(19) United States
(12) Patent Application Publication
(10) Pub. No.: US 2004/0160519 A1
(43) Pub. Date: Aug. 19, 2004

(54) Image processor, image-processing method, and image-processing program product

(75) Inventor: Satoru Horita, Tochigi (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/775,084

(22) Filed: Feb. 11, 2004

(30) Foreign Application Priority Data
Feb. 14, 2003 (JP) P2003-036128

(51) Int. Cl. H04N 9/68

(52) U.S. Cl. 348/234

(57) ABSTRACT

An image-processing device is provided that comprises an input device and an image-processing unit. The input device inputs video signals of an original color image. The image-processing unit carries out a predetermined image altering process on luminance components of the video signals. The luminance components, which are subjected to the image altering process, and color-difference components of the video signals are combined. Thereby, video signals for an illustrational image, in which the outlines of the image features are made bold and the number of colors is reduced with respect to the number of colors in the original color image, are generated.

### BACKGROUND OF THE INVENTION

1. Field of the Invention

The present invention relates to an image processor, image-processing method, and an image-processing program product that create a visual effect in an image.

2. Description of the Related Art

In recent years, digital still cameras that capture optical images of an object and convert them to digital video signals, have been widely used. Such digital still cameras can transmit digital video signals to a computer and the like directly or indirectly via an external recording medium. Not only can an object image be displayed on a monitor as a color image, but the computer can also alter its visual appearance by using an image-processing program to chance the color of the image, and the program may be installed in the computer.

An example of an image altering process that alters the visual appearance of an image is an image altering process that converts an image to an illustrational image that expresses the image in monotonous colors by means of reducing the colors to a predetermined number of colors by altering the color of each pixel to one of the representative colors.

However, when a color of each pixel is assigned to the most similar color included in the restricted representative colors, the hue of the image is changed. Namely, a tint of the processed illustrational image differs from that of the original color image, since the color balance changes. Particularly, when expressing human skin color with two or three representative colors, there is substantial difference between the tints of the images before and after carrying out the image altering process.

### SUMMARY OF THE INVENTION

Therefore, an object of the present invention is to provide an image processor, image-processing method, and image-processing program product that can provide an illustrational image without changing its subjective color perception from that of an original color image.

According to the present invention, an image-processing device is provided that comprises an input device and an image-processing unit.

The input device inputs video signals of an original color image. The image-processing unit carries out a predetermined image altering process on luminance components of the video signals. Further, luminance components, which are subjected to the image altering process and color-difference components of the video signals are combined, so that video signals for an illustrational image in which the outlines of image features are made bold and the number of colors is reduced, with respect to the number of colors in the original color image, are generated.

Further, according to the present invention, an image-processing method is provided that comprises steps of inputting video signals, processing an image, and composing a signal.

The video signals of an original color image are input and a predetermined image altering process is carried out on luminance components of the video signals. Further, signal composition takes place, whereby the luminance components that have been subjected to the image altering process, and color-difference components of the video signals are combined for generating video signals for an illustrational image in which outlines of the image features are made bold and the number of colors is reduced, with respect to the numbers of colors in the original color image.

Further, a computer program product for image processing is provided that comprises an input module, an image-processing module, and a signal composition module.

The input module inputs video signals of an original color image. The image-processing module carries out a predetermined image altering process on luminance components of the video signals. The signal composition module combines the luminance components, which have been subjected to the image altering process, and color-difference components of the video signals, for generating video signals for an illustrational image in which the outlines of image features are made bold and the number of colors is reduced with respect to the number of colors in the original color image.

### BRIEF DESCRIPTION OF THE DRAWINGS

The objects and advantages of the present invention will be better understood from the following description, with reference to the accompanying drawings in which:

FIG. 1 is a block diagram illustrating principal components of a digital still camera provided with an image processor of the first embodiment of the present invention;

FIG. 2 schematically illustrates each stage of the signal altering process which is carried out in the image signal processor;

FIG. 3 schematically illustrates the flow of the image altering process together with values of the luminance level that changes in the process;

FIG. 4 is a graph showing the input-output properties of the gradation conversion;

FIG. 5 illustrates the luminance components of the original color image and the illustrational image by comparison between the thin-line mode and the thick-line mode;

FIG. 6 is a flowchart of the main routine of the image-processing program carried out in the control circuit;

FIG. 7 is a flowchart of the image altering process subroutine for the illustration mode in FIG. 6.;

FIG. 8 illustrates the second embodiment of the present invention; and

FIG. 9 illustrates the third embodiment of the present invention.

### DESCRIPTION OF THE PREFERRED EMBODIMENTS

The present invention is described below with reference to the embodiments shown in the drawings.

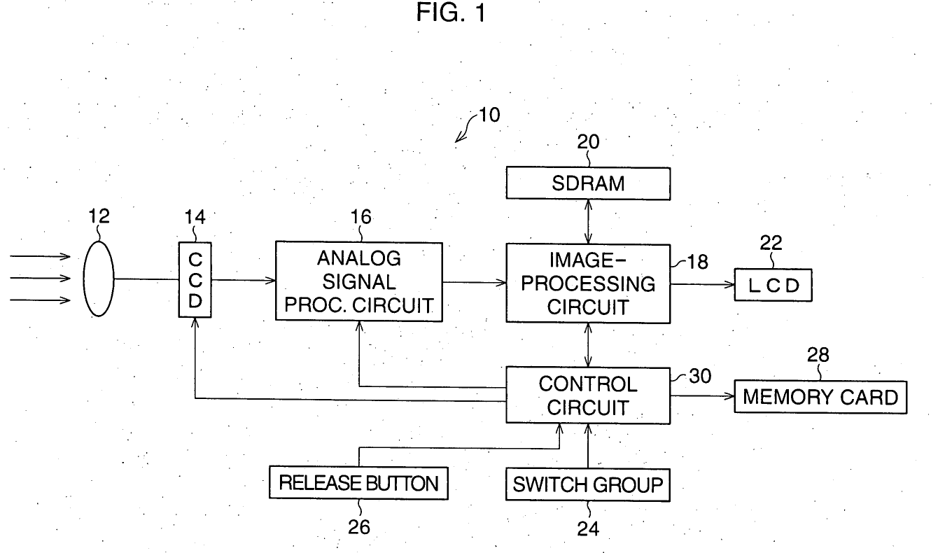

FIG. 1 is a block diagram illustrating principal components of a digital still camera provided with an image processor of the first embodiment of the present invention.

The digital still camera 10 comprises a photographing optical system 12 that forms an image of an object, and an imaging device, such as a CCD 14, that carries out photoelectrical conversion of an optical image of the object which is formed on the image plane by the photographing optical system 12. The digital still camera 10 uses a single CCD 14 which is provided with an on-chip color filter array so that each of the three primary color signals are generated from the CCD 14. Namely, the two-dimensionally arrayed color filters for the three primary colors (i.e., Red, Green, and Blue) are provided on each of the pixels on the image plane of the CCD 14, so that the CCD 14 provides one piece of color information for each one pixel.

Analog image signals for one frame, which are output from the CCD 14, are fed to an analog signal processor 16 in sequence and subjected to A/D conversion after being amplified to an appropriate signal level. The converted digital signals are then fed to an image processor 18 as a frame of digital image signals (hereinafter, referred to as pixel data) and are temporally stored in a built-in memory, such as an SDRAM 20. The image-processor 18, in cooperation with the SDRAM 20, generates video signals by carrying out various types of later detailed image altering processes on the above pixel data. These video signals comprise luminance signals (luminance component) including information of image brightness, and color difference signals (color difference component) including information of image color. Accordingly, the photographing optical system 12, CCD 14, analog signal processor 16, image processor 18, and SDRAM 20 function as an input device for obtaining video signals for an original color image.

The digital still camera 10 comprises a monitor, such as an LCD 22, for indicating a captured object image and menus, a switch group 24 for setting imaging modes or imaging conditions, and a shutter release button 26 for capturing a still image. Immediately after turning on the power or when a live-view of an image is selected by operating the switch group 24, the following processes: such as capturing one frame of image signals by the CCD 14, processing an image using the analog signal processor 16 and the image processor 18, updating pixel data stored in the SDRAM 20, and indicating an image on the LCD 22; are cyclically repeated at a constant period so that the object image displayed on the LCD 22 is displayed as a live view.

When the release button 26 is depressed during this live-view operation, the CCD 14 is exposed for a period of time that is required for capturing a still image and one frame of video signals is generated in the image processor 18. The video signals may be compressed in accordance with predetermined coding and stored in a memory card 28. For example, the video signals may be converted to compressed image data of JPEG standard. At this time, the image display on the LCD 22 is repeated by using video signals generated when the release button 26 was depressed, so that the object image is displayed on the LCD 22 as a still image. The memory card 24 is an external recording medium which is attachable to or detachable from the digital still camera 10. An example of the memory card 24 is a compactflash (registered trademark to SanDisk). A control circuit 30 (or micro computer) controls all of the processes and operations carried out in each component of the digital still camera 10.

The digital still camera 10 of the first embodiment has an illustration mode and a normal mode. The illustration mode is a mode that converts an image captured by the CCD 14 (hereinafter, referred to as an original color image) to an illustration like image (hereinafter, referred to as an illustrational image) by applying image altering process that enhances or thickens outlines of contours or edges of features in the object image, and reduces the number of colors. Further, the illustration mode stores the produced illustrational images in the memory card 28. On the other hand, the normal mode is a mode that captures original color images and stores them in the memory card 28 without applying the above-discussed image altering process. One of the illustration mode or the normal mode can be manually selected by operating a switch provided in the switch group 24, so that signal processing in the image processor 18 is selected in accordance with the mode which was selected before the depression of the release button 26.

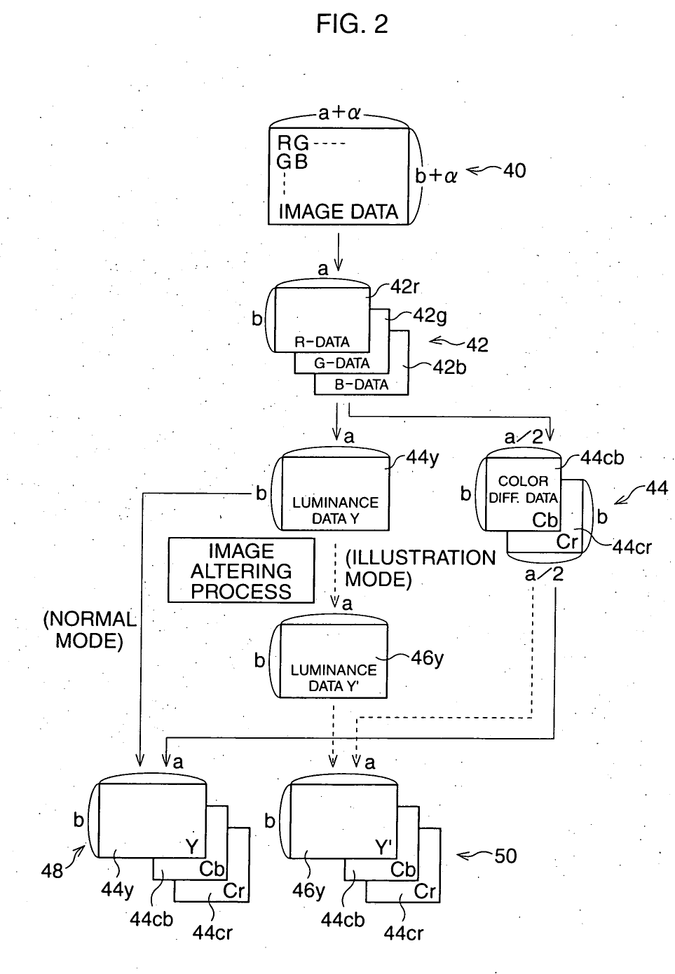

FIG. 2 schematically illustrates each stage of the signal processing which is carried out in the image signal processor. The pixel data 40 from the analog signal processor 16 is stored in a predetermined memory area of SDRAM 20 which corresponds to (a+α)×(b+α) pixels (where a, b, and α are integers). The variable “a” represents the number of pixels in the horizontal direction, that is, 2048 in the present embodiment. On the other hand, the variable “b” represents the number of pixels in the vertical direction, that is, 1536 in the present embodiment. As will be described later, although the number of pixels is given by a×b in the final stage, the pixel data has marginal pixels α for both the horizontal and vertical directions, in order to interpolate data between pixels, which will also be discussed later.

The pixel data 40, where a piece of color information that relates to one color is assigned to each of the pixels, is input to the image processor 18 and then subjected to the pixel data interpolation process, white-balance correction process, gamma-correction process, and color-matrix process for color separation and chroma adjustment. Thereby, the pixel data 40 is converted to the three-primary-color data 42 where a set of color information including three primary colors is assigned to each of the pixels. The three-primary-color-data 42 is comprised of R-color data 42r of a×b pixels, G-color data 42g of a×b pixels, and B-color data 42b of a×b pixels. Each of the signals forming the respective color data, is represented as numerical data having 256 (8 bits) values.

The three-primary-color data 42 is converted to image data 44 by a YCbCr matrix process and stored in a memory area of an SDRAM 20 which is different from the area occupied by the pixel data 40. The image data 44 is comprised of luminance data 44y which relates to luminance signals Y for a×b pixels, and color-difference data 44cb and 44cr which relate to respective color-difference signals Cb and Cr, where the numbers of pixels are both a/2×b pixels. Each of the luminance signals Y forming the luminance data 44y is numerical data which represents the luminance level of the corresponding pixel, in 256 steps, so that it represents one of the integer values within the interval from 0 to 255.

When the normal mode is selected by the switch group 24, the luminance data 44y and the color difference data 44cb and 44cr, stored in the SDRAM 20, are input to the image processor 18 and multiplexed, so that multiplexed signals are fed to the LCD 22 as video signals 48 of an original color image. Further, the video signals 48 are also fed to the control circuit 30 and subjected to the encoding process to be converted to compressed image data and then stored in the memory card 28.

On the other hand, when the illustration mode is selected by the switch group 24, the luminance data 44y, stored in the SDRAM 20, are fed to the image processor 18 and subjected to the image altering processes, which will be described later, so that they are converted to luminance data 46y for the processed luminance signals Y′. The luminance data 46y and the color difference data 44cb and 44cr, which has not been subjected to the image altering process, are combined together in the image processor 18, and then fed to the LCD 22 as video signals 50 of an illustrational image. Further, the video signals 50 are also fed to the control circuit 30 and are subjected to the encoding process to be converted to compressed image data and then stored in the memory card 28. When the illustration mode is selected, the chroma saturation is adjusted to the value higher than that in the normal mode in the color-matrix process, so that an illustrational image is produced in vivid color which diminishes the reality of the image and enhances illustrational degree.

As described above, the image processor 18 in combination with the SDRAM 20 functions as an image-processing unit for carrying out the image altering process for the luminance signals Y, and as a composite-processing unit for generating the video signals 50 for the illustrational image, produced by combining the processed luminance signals Y′ and the color difference signals Cb and Cr of the original color image.

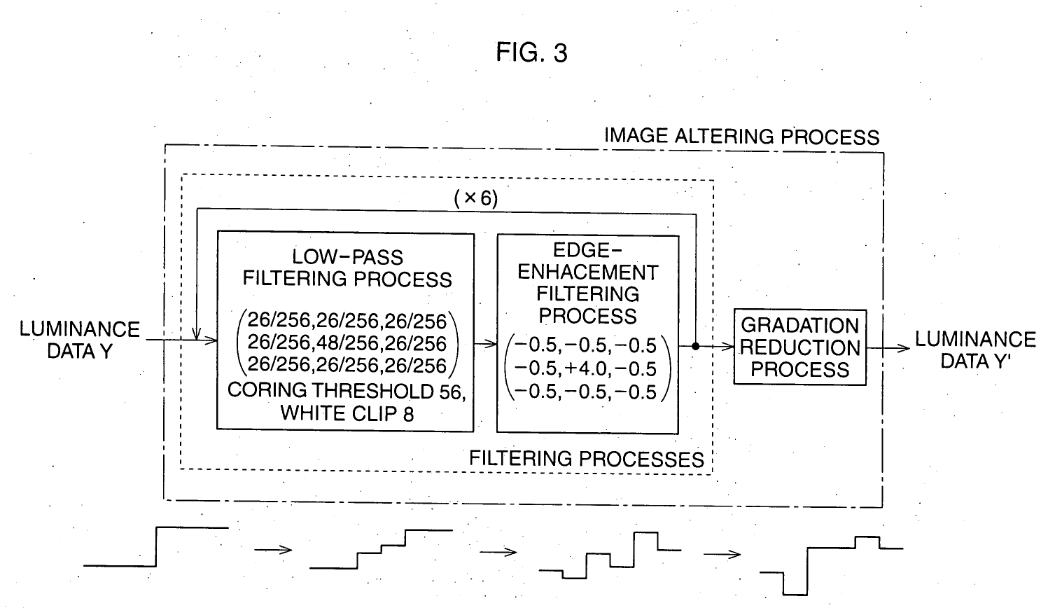

With reference to FIG. 3, the image altering process in the present embodiment will be described in detail FIG. 3 schematically illustrates the flow of the image altering process together with values of the luminance level that change in the process. The image altering process comprises filtering processes and a gradation-reduction process. The filtering processes include a low-pass filtering process and an edge-enhancement filtering process to filter the luminance data 44y for a plurality times, for example seven times. The gradation-reduction process reduces gradation or the gray scale steps of the luminance data 44y, subsequent to the filtering processes.

The low-pass filtering process smoothens variations of the luminance levels between a target pixel and its surrounding pixels. Namely, it is a shade off process that mashes the detail. For example, a 3×3 matrix, which is given the following filter coefficients, is used as the low-pass filter. Namely, the sum of the target pixel value multiplied by 48/256 and the surrounding eight pixel values, each multiplied by 26/256, is defined as a new luminance value of the target pixel. This process is performed for each of the a×b pixels.

Coefficients of Low-pass filter:

$$( \begin{matrix}26 / 256 & 26 / 256 & 26 / 256 \\ 26 / 256 & 48 / 256 & 26 / 256 \\ 26 / 256 & 26 / 256 & 26 / 256\end{matrix} )$$

The edge-enhancement filter enhances variation of the luminance level between the target pixel and the surrounding pixels. For example, a 3×3 matrix, which is given the following filter coefficients, is used as the edge-enhancement filter. Namely, the sum of the target pixel value multiplied by 4 and the surrounding eight pixel values, each multiplied by −0.5, is added to the original target pixel value and defined as a new luminance value of the target pixel. This process is also performed on each of a×b pixels.

Coefficients of Edge-enhancement filter:

$$( \begin{matrix}- 0.5 & - 0.5 & - 0.5 \\ - 0.5 & + 4.0 & - 0.5 \\ - 0.5 & - 0.5 & - 0.5\end{matrix} )$$

The above edge-enhancement filtering process has a coring threshold value (=56) so that when the value of a target pixel is less or equal to this coring threshold value, the target pixel value is maintained. Thereby, enhancement of noise components is prevented. Further, for the pixels having high luminance values, a clip value (=8) is applied. Namely, when the difference between a target pixel value and the surrounding pixel value is larger than the clip value, the value of the target pixel is replaced by the clip value. Thereby, enhancement of the pixels having high luminance value is prevented.

Around the outline portion of objects or features in the original color image, there is substantial difference in luminance levels between adjacent pixels. The difference in the luminance levels may be slightly reduced by the low-pass filter but the outline can be made bold. Further, the pixel value of the outline portion is shifted to the dark side by the edge-enhancement filtering process. In the filtering processes of the first embodiment, the low-pass filtering process and the subsequent edge-enhancement filtering process are repeatedly, seven times, carried out on the luminance data 44y. Therefore, the thickness of the outline portion is broadened and its luminance levels are relatively decreased. Namely, the thickness of the outlines in the illustrational image is increased and their brightness is attenuated, that is, toward the black level.

The number of times the filtering-processes using the low-pass filtering process and the edge-enhancement filtering process is carried out is not limited to seven. As the repetition increases, the outlines in the illustrational image become thicker and details become more attenuated, so that the area which is lacking a fine detail is broadened. As the repetition decreases, the outlines in the illustrational image remain relatively narrow and more details are remain. Therefore, for attenuating the reality of the image, one should increase the number of times the filtering processes are carried out. On the other hand, to maintain reality and to keep the image close to the original color image, one should merely decrease the number of times for the repetition. Further, in the first embodiment, only a single predetermined value is preset for the number of the filtering processes is repeated, so that only one type of filtering processes need be executed. However, the filtering processes may be configured to include a plurality of selective values for the number of times for the processes are carried out, in order to enable various types of filtering processes which are selectively carried out in accordance with mode selected by an operator. Furthermore, the filtering order of the low-pass filter and the edge-enhancement filter in the filtering processes is not restricted to that of the first embodiment. Therefore, a similar effect can also be obtained by changing the order of that in the first embodiment.

The filter coefficients of the low-pass filter and the edge-enhancement filter are also not restricted to the coefficients illustrated in the first embodiment, but each set of coefficients for both filters should be suitably given so as not to regard noise components as an outline.

As described above, the low-pass filter and the edge-enhancement filter in the first embodiment are configured to have comparatively small 3×3 matrices, thereby to reduce the amount of memory required in the image processor 18, which is occupied by the coefficients. The filter effects are gradually enhanced by recursively carrying out the filter processes. In general, the sampling area used in the filtering processes is required to be expanded in order to enhance the filter effects. Namely, this requires a large image processor 18 or increased processing time when using software programs in place of a hardware filter processor. Therefore, conventionally, it is generally believed that providing an illustrational image generator for electronic devices, such as a digital still camera 10, for which the weight and dimensions have restrictions based on handling requirement, is difficult or substantially impossible. However, according to the first embodiment of the present invention, the filter matrix is comparatively small and it requires a small amount of memory. Thereby, the illustrational image generator can be provided for the digital still camera 10.

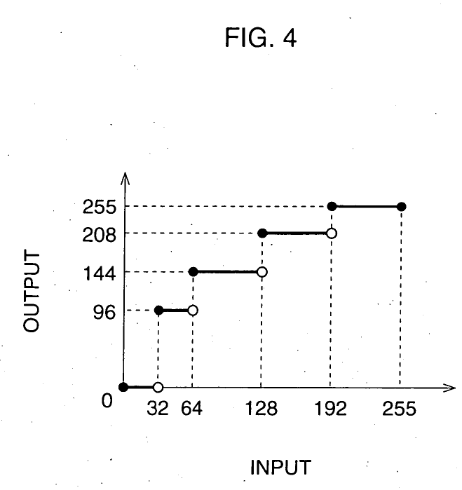

The gradation-reduction process is a process that reduces the number of luminance level steps (namely reduction of gradation or gray scale) of luminance data 44y for which the filtering processes have already been performed. The gradation-reduction process reduces the number of gradations from “256” to “5” by means of referring to a look-up table. The input-output properties of the gradation conversion (gradation-reduction), which correspond to the look-up table, are illustrated by a graph in FIG. 4. Namely, when an input value (integer) Vᵢₙ is in the range of 0≦Vᵢₙ<32, the output value Vₒᵤₜ is “0”. Further, Vₒᵤₜ=96 when 32≦Vᵢₙ<64, Vₒᵤₜ=144 when 64≦Vᵢₙ<128, Vₒᵤₜ=208 when 128≦Vᵢₙ<192, and Vₒᵤₜ=255 when 192≦Vᵢₙ≦255. Accordingly, the luminance signals Y′ are assigned to one of the values 0, 96, 144, 208, and 255. Thereby, the luminance data 46y is represented by five steps of luminance levels, so that color variation due to the brightness in the illustrational image is attenuated, that is, the number of reproduced colors is reduced. Further, the small variations in the luminance vanishes. As described above, the color difference data Cb and Cr for the illustrational image is equivalent to that for the original color image, so that the number of colors is reduced without changing the hue from the original color image. Namely, an illustrational image, which seems as if it were roughly painted, can be obtained without changing the color tone of the original color image.

In the gradation-reduction process of the first embodiment, the luminance levels are shifted to relatively higher levels, so that the brightness of the illustrational image is generally increased. In the input-output properties indicated in FIG. 4, the luminance levels under the value of “32”, which might be recognized as a part of an outline, are converted to “0” level, and the luminance levels larger or equal to the value “96”, which give substantial affect to the reproduction of color in the illustrational image, are almost uniformly distributed. Note that, the luminance levels after the gradation-reduction process are not restricted to the above five levels and also the number of levels is not restricted to five. If the number of levels for the gradation or luminance is large, the detail in the illustrational image will be greater and the reduction in the number of colors will be small. However, if the number of levels for the gradation is too small, the number of colors is small and the image is lack enough detail, with fewer color variations.

The image processor 18 may carry out a resolution reduction process on the original color image, to reduce the resolution of the image, before carrying out the image altering process including the filtering processes for the luminance data 44y. Further the resolution is restored to the resolution in the original color image after performing the filtering processes, by a resolution restoring process. Thereby, the sampling area for each filtering operation is relatively extended thus the width of outlines can be thickened and enhanced.

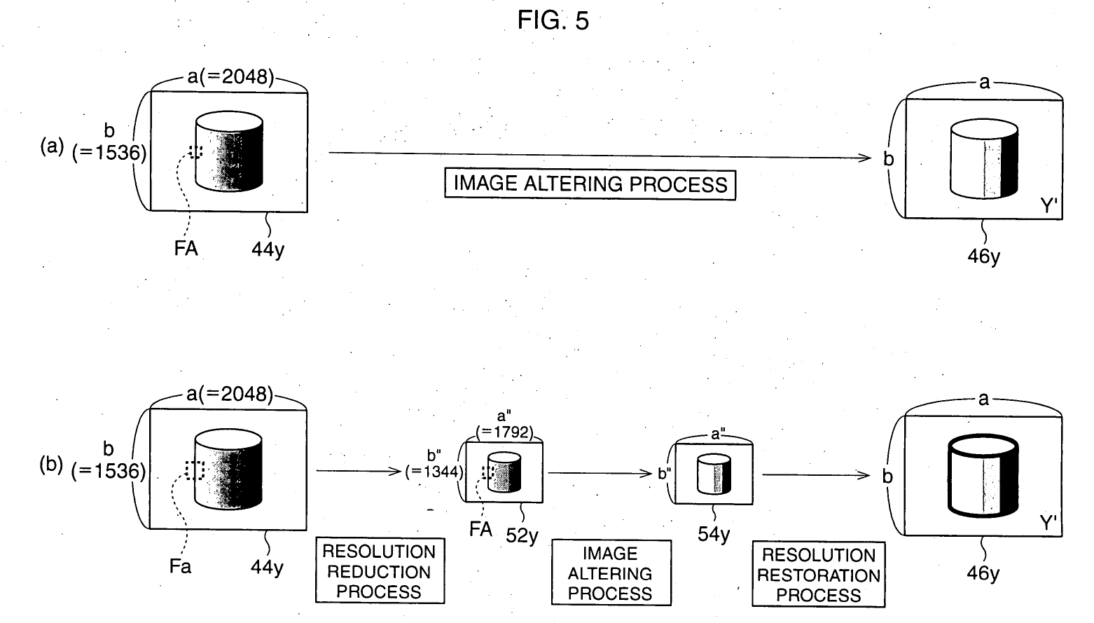

FIG. 5(a) illustrates the luminance components of the original color image and the illustrational image when the image altering process using only the filtering processes is applied to the luminance data, that is, without the resolution conversion processes (the resolution reduction process and the resolution restoring process). On the other hand, FIG. 5(b) illustrates the luminance components of the original color image and the illustrational image when the resolution conversion processes are applied before and after the filtering processes in the image altering process.

In FIG. 5(b), in detail, the resolution of the luminance data 44y having a(=2048)×b(=1536) pixels is reduced by the resolution reduction process. In the resolution reduction process, the number of pixels is reduced to a″(=1792)×b″(=1344) pixels by using the bilinear method, which splits image area into a plurality of image areas and carries out the linear interpolation based on the surrounding data levels, or the bicubic interpolation method, which uses three-dimensional function interpolation based on the surrounding data levels. The image altering process is carried out for the luminance data 52y of which the image area is reduced. Further, the number of pixels for the resolution-reduced luminance data 54y having a″×b″ pixels is restored to that for the original resolution. That is, in the resolution restoring process, the number of pixels is increased to a×b pixels which is equivalent to that of the original color image, by using the pixel interpolation methods discussed above. Namely, the luminance data with a×b pixels, which is obtained by the resolution restoring process, is regarded as the luminance data 46y of the illustrational image.

With reference to FIG. 5(a) and FIG. 5(b), the outline of the object, such as a cylinder, is comparatively thicker in FIG. 5(b) in which the resolution is reduced before the image altering process. This is because the size of the images that are subjected to the image altering process is relatively reduced during the filtering processes of FIG. 5(b), since after the resolution reduction process, one pixel in the luminance data 52y corresponds to a plurality of pixels in the luminance data 44y of the original color image. Consequently, although the filter sampling area FA (3×3 pixels) in the filtering processes is the same in both FIG. 5(a) and FIG. 5(b), the substantial filter sampling area for a×b pixels of the luminance data 44y is different in each of FIG. 5(a) and FIG. 5(b). In the figures, the filter sampling areas are indicated by “FA” and the substantial filter sampling area for the luminance data 44y in FIG. 5(b) is indicated by “Fa”. As the rate of reduction for the resolution increases, namely as the number of pixels a “xb” for the luminance data 52y is reduced, the substantial filter sampling area “Fa” is relatively enlarged so that the outlines become thicker.

As described above, without increasing the number of repetitions that the low-pass filtering process and the edge-enhancement filtering process are carried out in the image altering process, the outlines of the object can be made bold by carrying out the resolution conversion processes before and after the image altering process. Therefore, the processing time is reduced compared to when the numbers of repetitions is increased for enhancing the outlines and making them bold. What is notable here is that the luminance information of the original color image is neglected or lost during the reduction process of the resolution. Therefore, the detailed variance of the luminance can be eliminated over a relatively large area compared to the case of merely increasing the number of times the filtering processes are repeated, so that illustrational tone can be enhanced.

Note that, whether to apply the resolution conversion processes before and after the image altering process as illustrated in FIG. 5(b) is determined in accordance with the mode which is set by operation of the switch group 24. Namely, when the “thin-line mode” is selected by the switch group 24, the image processor 18 only carries out the image altering process as shown in FIG. 5(a) On the other hand, when the “thick-line model” is selected, the resolution conversion processes are carried out before and after the image altering process, as shown in FIG. 5(b).

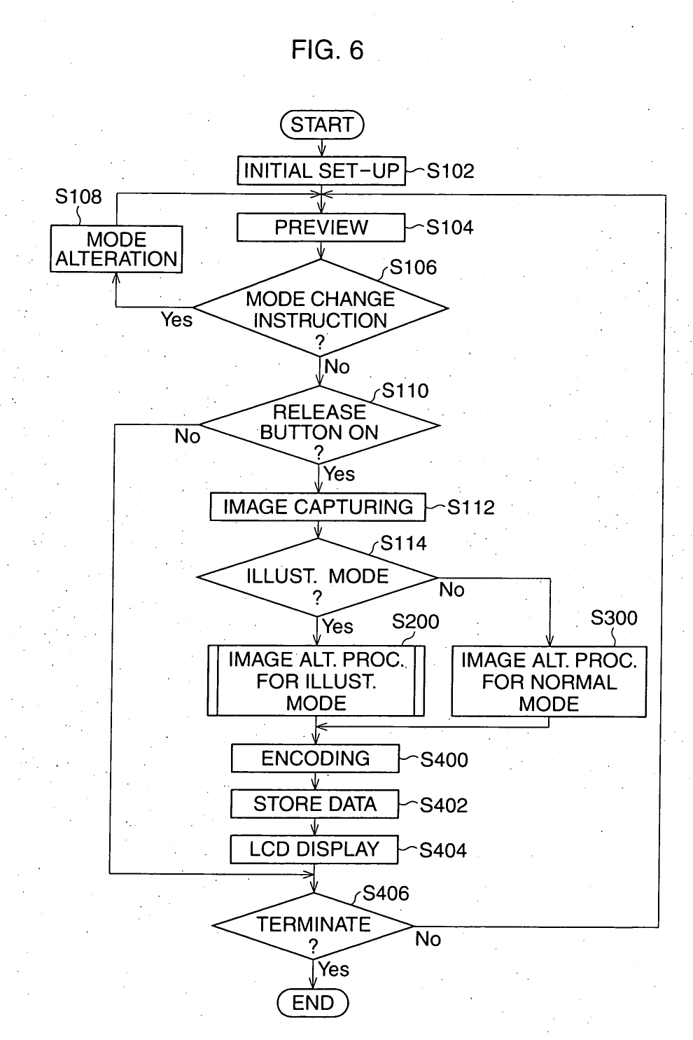

FIG. 6 is a flowchart of the main routine of the image-processing program carried out in the control circuit 30. The image-processing program is installed in a memory (not shown) of the control circuit 30 and is executed when the main power of the digital still camera 10 is turned on.

In Step S102, a variety of initial setup steps are carried out. In this initialization, the photographing conditions, modes, and so on, which are stored in a memory (not shown) during the last operation, just before turning off the power, are restored. At this time, one of the normal mode or the illustration mode is determined. Further, one of the thin-line mode or thick-line mode, which determines the width or boldness of the outlines when producing illustrational image, is determined.

In Step S104, the live-view is started. In detail, the imaging operation using the CCD 14 and the image display operation using the LCD 22 are cyclically carried out at a predetermined interval, so that a live view of an object is displayed on the LCD 22. When the current mode is altered to another by operating the switch group 24 (Step S106), while carrying out the live-view operation, the mode is switched to another mode in Step S108, so that the live-view operation of Step S104 is executed according to the newly selected mode.

When it is determined that there is no instruction for mode alteration, in Step S106, whether the shutter release button 26 is depressed or whether the imaging is instructed is determined in Step S110. Further, if the shutter release button 26 is not depressed, whether the termination or the shutting off of the power has been instructed, is determined in Step S406, and if not, it returns to Step S104. Namely, if the release button 26 is not depressed, the live-view operation is continued until the power is shut off.

When the release button 24 is depressed and the image capturing is instructed in Step S110, the imaging operation is then carried out in Step S112. Namely, the exposure time is calculated in the control circuit 30 based on the photographing conditions which are preset in Step S102 or the conditions updated in Step S108, and then electrical charge accumulates in the CCD 14 for the exposure time. The one frame of analog signals from the CCD 14 is stored in the SDRAM 20 as the pixel data 40 (see FIG. 2) via the analog signal processor 16 and image processor 18.

In Step S114, whether the illustration mode is selected is determined. When the illustration mode has been selected, the process proceeds to Step S200 and the image altering process due to the illustration mode is carried out, so that the pixel data 40 stored in the SDRAM 20 is fed to the image processor 18 and the video signals 50 of the illustrational image are produced. On the other hand, when it is determined that the illustration mode has not been selected, that is, when the normal mode has been selected, the process proceeds to Step S300 and the image altering process due to the normal mode is carried out, so that the pixel data 40 stored in the SDRAM 20 is fed to the image processor 18 and the video signals 48 of the original color image are produced.

The video signals 50 for the illustrational image, which is produced in Step S200, or the video signals 48 for the original color image, which is produced in Step S300, are compressed in accordance with the encoding process based on the JPEG standard in Step S400, and are then stored in the memory card 28 in Step S402, as compressed image data. Further, in Step S404, the captured still image is displayed on the LCD 404 for a predetermined time period. Note that, Step S404 maybe performed before the encoding process (Step S400). When the indication of the still image on the LCD 404 (S404) is completed, whether to terminate the processes is determined in Step S406. If the termination is not instructed, the process returns to the live-view operation at Step S104. On the other hand, if the termination is instructed, this image-processing program is terminated.

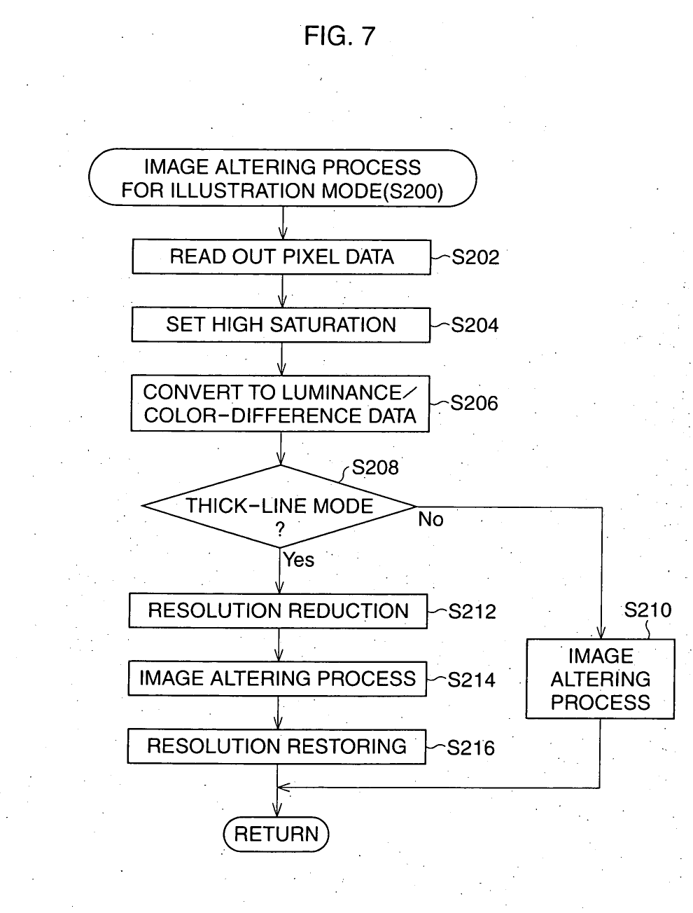

FIG. 7 is a flowchart of the image-processing subroutine for the illustration mode (S200) shown in FIG. 6. In Step S202, the pixel data 40 is input to the image processor 18 from the SDRAM 20. In Step S204, the image processor 18 is set so that the levels of saturation in the color-matrix process become higher than those in the normal mode. Further, the pixel data 40 is converted to RGB primary data 42 and converted to the luminance data 44y and the color difference data 44cb, 44cr, and then stored in the SDRAM 20, in Step S206.

In Step S208, whether the thick-line mode is selected is determined. When it is determined that the thick-line mode is not selected, the mode is regarded as the thin-line mode and the image altering process of Step S210 is carried out. Namely, the video signals of the illustrational image with relatively thin outlines as shown in FIG. 5(a) are produced. On the other hand, when it is determined in Step S208 that the thick-line mode is selected, the resolution reduction process of Step S212, the image altering process of Step S214, and the resolution restoring process of Step S216 are carried out in turn, so that the video signals of the illustrational image with relatively thick outlines as shown in FIG. 5(b) are produced. The image altering processes in Step S210 and Step S216 are substantially the same, that is, the low-pass filtering process and the edge-enhancement filtering process are repeatedly performed, seven times, and then the gradation-reduction process is carried out (see FIG. 3). When Step S210 or Step S216 is completed, this image-processing subroutine for the illustration mode ends and the process returns to the main routine.

As discussed above, the image-processing unit of the first embodiment, which is incorporated into the digital still camera 10, obtains an original color image corresponding to an optical image of an object by using the CCD 14, and produces an illustrational image, in which outlines are bold and the number of colors of which is reduced, by carrying out the image altering process for the original color image. In the first embodiment, the image altering process is carried out for only the luminance components of the original color image; so that the original color image can be processed into an illustrational image without altering its hue, thus without damaging the original color tone. Further, the illustrational image is obtained by recursively carrying out the low-pass filtering process and the edge-enhancement filtering process, thereby the desired illustrational effects (i.e., an illustrational image with bold outlines and lacking a fine detail) can be obtained even though the filter-sampling area is comparatively small. Further, when carrying out the resolution conversion processes before and after the image altering process, the filter sampling area is substantially enlarged, so that the time necessary for the image altering process can be reduced. In the illustration mode, the vivid illustrational image can be obtained, since the saturation is preset to the higher levels.

Note that, the input device for obtaining an original color image is not restricted to the digital still camera 10 of the first embodiment. Namely, the device may be an image scanner that converts an image of a developed photograph, a film, and so on, to video signals. In such a case, the image processing function may be incorporated into the scanner itself or into a computer system that is connected to the scanner.

In the first embodiment, the image altering process in Step S210 and Step S214 is substantially the same, however, the number of times the low-pass filtering process and the edge-enhancement filtering process are carried out may be different in each of the steps. Further, only two patterns of illustrational degrees, such as the thin-line mode and the thick-line mode, are provided in the first embodiment, however more than two patterns or modes may be provided.

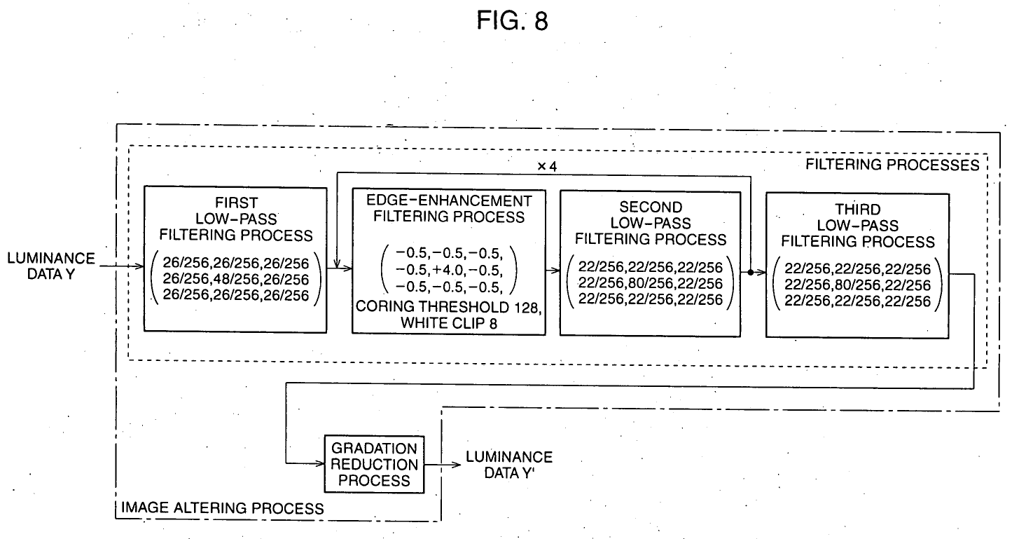

FIG. 8 illustrates the second embodiment of the present invention, which is another example of an image altering process for the thin-line mode that is carried out in the image processor 18 (which corresponds to FIG. 5(a) and in Step S210 of FIG. 7 for the first embodiment). FIG. 8 corresponds to FIG. 3 of the first embodiment. The other constructions are similar to those in the first embodiment, so that the explanations for the other constructions will be excluded.

In the filtering processes of the second embodiment, the first low-pass filter for eliminating noise in a high frequency band is used before recursively carrying out the edge-enhancement filtering process, for enhancing and thickening outlines, and a second low-pass filtering process, for five times. Finally, a third low-pass filter is used for eliminating noise generated by the enhancement.

The filter coefficients of the first low-pass filter are equivalent to those in the first embodiment. On the other hand, the central coefficient value among the filter coefficients for the second and third low-pass filters is relatively small when it is compared to the filter coefficients in the first low-pass filter, as described below.

Coefficients of First and Second Low-pass Filters:

$$( \begin{matrix}22 / 256 & 22 / 256 & 22 / 256 \\ 22 / 256 & 80 / 256 & 22 / 256 \\ 22 / 256 & 22 / 256 & 22 / 256\end{matrix} )$$

The edge-enhancement filter of the second embodiment is the same as that of the first embodiment, except that the coring threshold is preset to 126, and not 58. When the value of the coring threshold is large, the noise reduction effect is increased.

In the second embodiment, the order of processing the edge-enhancement filtering process and the low-pass filtering process is opposite to that in the first embodiment and the number of times the process is repeated is five instead of seven. Further, the low-pass filters are used before and after their repetition processes. These are the differences between the second embodiment and the first embodiment. Particularly, the final low-pass filtering process can prevent the appearance of unnatural white lines along black outlines generated by the edge-enhancement filtering process. When compared to the first embodiment, the number of times the filtering process is repeated is reduced from seven to five, so that the deterioration of details in an image is restrained and an illustrational image that remains close to reality is obtained.

As well as in the first embodiment, in the image-processing unit of the second embodiment, the image altering process is only carried out for the luminance components of the original color image, so that an illustrational image can be obtained without changing the original color image's hue, thus without damaging the original color perception. Further, when the illustrational image is produced by means of carrying out the edge-enhancement filtering process and the low-pass filtering process recursively, the illustrational image with bold outlines and a reduced number of colors is obtained even when the filter sampling area is comparatively small.

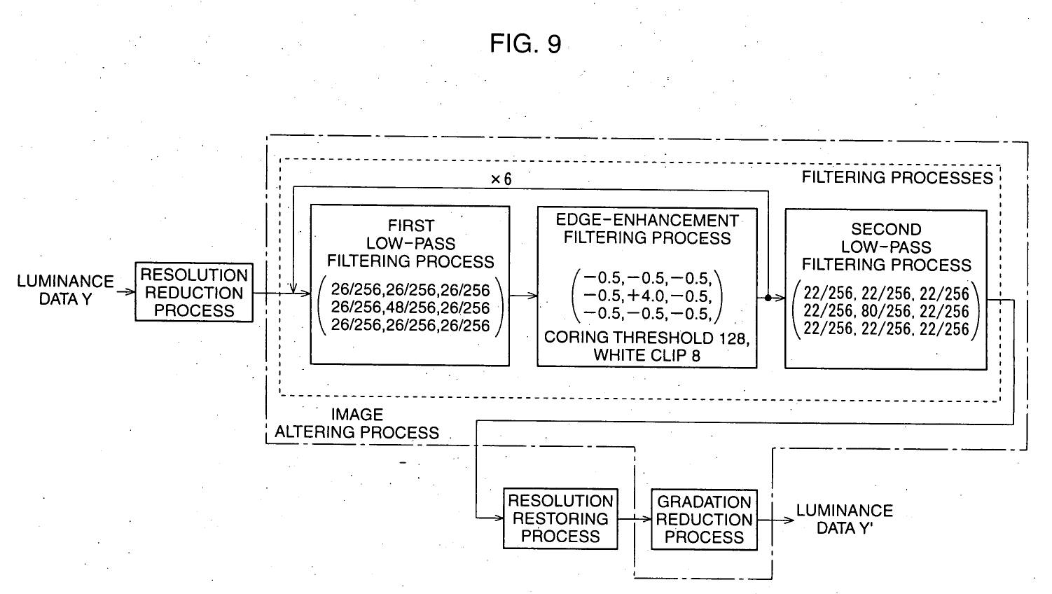

FIG. 9 illustrates the third embodiment of the present invention, which is another example of the image altering process for the thick-line mode that is carried out in the image processor 18 (which corresponds to FIG. 5(b) and Steps S212 to S216 of FIG. 6 of the first embodiment). The other constructions are similar to those in the first embodiment, so that the explanations for these other constructions will be excluded.

In the filtering processes of the third embodiment, the first low-pass filtering process and the edge-enhancement filtering process are recursively carried out for seven times, and then the second low-pass filtering process, for eliminating enhanced noise, is carried out. The filter coefficients of the first and second low-pass filters are the same as those in the first embodiment. Further, the filter coefficients of the edge-enhancement filter, the coring threshold value, and the clip value are also the same as in the first embodiment. However, in the third embodiment, the second low-pass filter is additionally used in the final step of the filtering processes.

In the first embodiment, the resolution restoring process is carried out after the gradation-reduction process, namely, after the completion of the image altering process. However, in the third embodiment, the resolution restoring process is carried out before the gradation-reduction process and is included in the above image altering process. The resolution reduction process and the resolution restoring process are performed in order to substantially expand the filter sampling area, thereby the resolution restoring process is only required to be performed after the filtering processes.

As in the first embodiment, when the resolution restoring process is carried out after the gradation-reduction process, since the restoration of the resolution is based on the surrounding data values, the resultant luminance value is obtained as a value between the levels of the surrounding data, a level which is not determined in the gradation-reduction process. On the other hand, when the gradation-reduction process is carried out after the resolution restoring process, as in the third embodiment, luminance values for every pixel can be assigned to the desired preset levels. However this means that the time for the gradation-reduction process itself increases with respect to the first embodiment, since the number of pixels to be processed increases compared to the first embodiment.

As well as in the first and second embodiments, in the image-processing unit of the third embodiment, the image altering process is only carried out for the luminance components of the original color image, so that an illustrational image can be obtained without changing the original color imagers hue, thus without damaging the original color perception. Further, the illustrational image is produced by means of carrying out the edge-enhancement filtering process and the low-pass filtering process recursively. An illustrational image with bold outlines and a reduced number of colors is obtained even when the filter sampling area is comparatively small.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2003-036128 (filed on Feb. 14, 2003), which is expressly incorporated herein, by reference, in its entirety.

1. An image-processing device, comprising:
an input device that inputs video signals of an original color image; and
an image-processing unit that carries out a predetermined image altering process on luminance components of said video signals;
wherein said luminance components, subjected to said image altering process, and color-difference components of said video signals are combined, so that video signals for an illustrational image in which the outlines of image features are made bold, and the number of colors is reduced with respect to the number of colors in said original color image, are generated.

2. A device according to claim 1, wherein said image altering process includes filtering processes in which a low-pass filter and an edge-enhancement filter are used to filter said luminance components, and a gradation-reduction process that reduces the steps of said luminance components.

3. A device according to claim 2, wherein said filtering processes are recursively carried out for a plurality of times.

4. A device according to claim 2, wherein said image-processing unit further carries out a resolution reduction process that reduces the number of pixels in said original color image before carrying out said filtering processes and a resolution restoring process that restores the number of pixels to said number of pixels in said original color image after carrying out said filtering processes.

5. A device according to claim 4, wherein said image-processing unit carries out said resolution restoring process after carrying out said gradation-reduction process.

6. A device according to claim 4, wherein said image-processing unit carries out said resolution restoring process before carrying out said gradation-reduction process.

7. A device according to claim 2, wherein said image-processing unit carries out said low-pass filtering process, said edge-enhancement filtering process, and said gradation-reduction process in this order in a first mode, and
wherein said image-processing unit carries out a resolution reduction process that reduces the number of pixels in said original color image, said low-pass filtering process, said edge-enhancement filtering process, said gradation-reduction process, and a resolution restoring process that restores the number of pixels to said number of pixels in said original color image, in this order in a second mode.

8. An image-processing method that comprises steps of:
inputting video signals of an original color image;
carrying out a predetermined image altering process on luminance components of said video signals; and
combining said luminance components that have been subjected to said image altering process, and color-difference components of said video signals for generating video signals for an illustrational image in which the outlines of image features are made bold and the number of colors is reduced with respect to the number of colors in said original color image.

9. A computer program product for image processing that comprises:
an input module that inputs video signals of an original color image; and
an image-processing module that carries out a predetermined image altering process on luminance components of said video signals;
a signal composition module that combines said luminance components, subjected to said image altering process and color-difference components of said video signals for generating video signals for an illustrational image in which the outlines of image features are made bold and the number of colors is reduced with respect to the number of colors in said original color image.
